(19) United States
(12) Patent Application Publication
(10) Pub. No.: US 2018/0271035 A1
(43) Pub. Date: Sep. 27, 2018

(54) VINE TRELLIS SYSTEM

(71) Applicant: Guy V. Tucker, Somerset, CA (US)

(72) Inventor: Guy V. Tucker, Somerset, CA (US)

(21) Appl. No.: 15/928,299

(22) Filed: Mar. 22, 2018

Related U.S. Application Data
(60) Provisional application No. 62/476,133, filed on Mar. 24, 2017.

(51) Int. Cl. A01G 17/06; A01G 9/12

(52) U.S. Cl. CPC A01G 17/06; A01G 9/12

(57) ABSTRACT

A trellis system for training a row of grape vines is disclosed. The trellis system comprises a frame supporting a first cordon wire and a second cordon wire, wherein the two cordon wires are substantially parallel to one another. The frame is mounted relative to the ground so that the first cordon wire and the second cordon wire are tilted relative to a horizontally level plane. In additional or alternatively, the first cordon wire and the second cordon wire can be tilted relative to the slope of the ground directly below the first cordon wire and the second cordon wire.

### PRIORITY

The present application claims the benefit of domestic priority based on U.S. Provisional Patent Application 62/476,133 filed on Mar. 24, 2017, the entirety of which is incorporated herein by reference in its entirety.

### BACKGROUND

For centuries, grapes have bene grown in vineyards. Whether for eating or for making wine, it is desirable for grape production on grape vines to be maximized and optimized. To this end, a viticultural science has been developed that has been effective in increasing grape yield and for even making grape vines grow in regions and on properties where it would have previously been difficult if not impossible.

Over the past twenty to thirty years, one of the biggest viticultural advancements has been in trellis design. Grape vine canopy management has greatly improved grape productivity and quality. Today's trellis systems generally fall into one of three categories: the single curtain systems (such as the two-wire vertical trellis, the vertical-shoot-positioned trellis, and the Smart-Dyson trellis), the vertically-divided double curtain (such as the Smart-Henry trellis and the Scott Henry trellis), and the horizontally-divided double curtain (such as the Geneva double curtain, the Wye trellis, and the Lyre trellis).

The horizontally-divided double curtain is increasingly gaining in popularity and offers advantages for many vineyard owners. For example, the horizontally-divided double curtain provides a desirably spread out canopy. The result of the spread is a favorable leaf-to-fruit ratio for photosynthesis. A conventional horizontally-divided double curtain includes two parallel cordon wires that lie on a horizontally-extending, level plane. The cordon wires straddle a vine trunk so that two cordons, or arms, of the vine may be secured onto respective cordon wires. Alternatively, when used in a row of vines, a first vine's cordons may be secured to a first cordon wire while the adjacent vine's cordons are secured to the second cordon wire.

However, the current vine trellis systems do not account for the aspect of the slope they on are. Therefore, there is a need for trellis system that accounts for the aspect of the slope it is on. There is further a need for an improved horizontally-divided double curtain trellis system.

### SUMMARY

The present invention satisfies these needs. In one aspect of the invention, a trellis system accounts for the aspect of the slope it is on.

In another aspect of the invention, an improved horizontally-divided trellis system is able to mimic a desired slope aspect.

In another aspect of the invention, a trellis system for training a row of grape vines comprises a frame supporting a first cordon wire and a second cordon wire, wherein the two cordon wires are substantially parallel to one another. The frame is mounted relative to the ground so that a line extending through the first cordon wire and the second cordon wire and substantially perpendicular thereto is tilted relative to a horizontally level plane. The line is also tilted relative to the slope of the ground directly below the first cordon wire and the second cordon wire.

In another aspect of the invention, a trellis system for training a row of grape vines comprises a frame supporting a first cordon wire and a second cordon wire, wherein the two cordon wires are substantially parallel to one another. The frame is mounted relative to the ground so that a line extending through the first cordon wire and the second cordon wire and substantially perpendicular thereto is tilted relative to a horizontally level plane. The vertical height of the first cordon from ground directly below is different than the vertical height of the second cordon from the ground directly below.

### DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1 is schematic side view of one version of a trellis system frame according to the invention,

FIG. 2 is a schematic side view of another version of a trellis system frame according to the invention;

FIG. 3A is a schematic diagram showing angular relationships according to one version of the invention;

FIG. 3B is a schematic diagram showing angular relationships and heights according to one version of the invention.

### DESCRIPTION

The present invention relates to trellis systems. In particular, the invention relates to trellis systems for growing grape vines. Although the system is illustrated and described in the context of being useful for grapes, the present invention can be used in other applications, such as with other fruit or flowers. Accordingly, the present invention should not be limited to the examples and embodiments described herein.

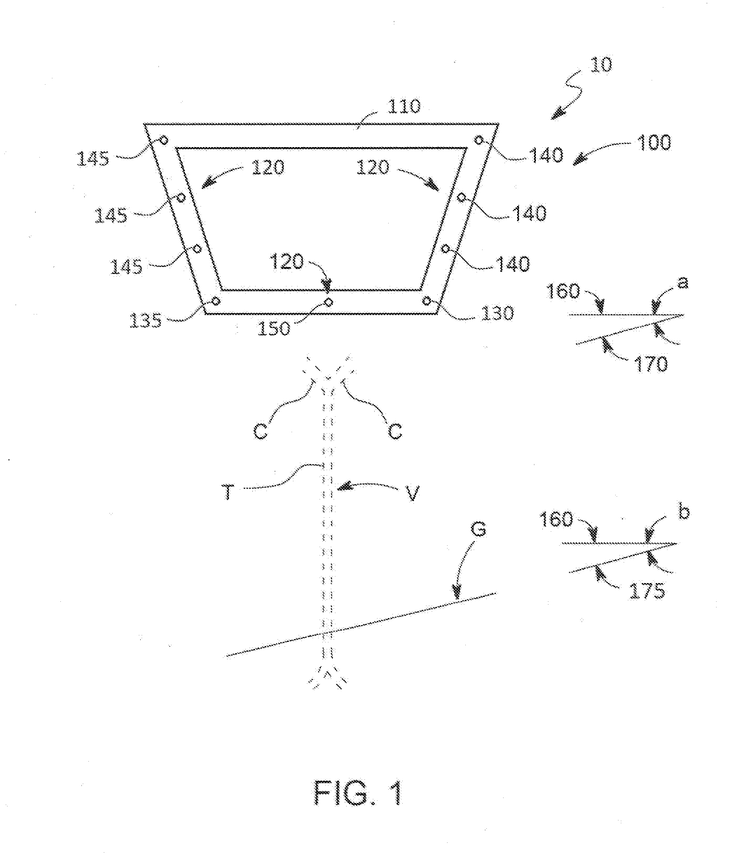

FIG. 1 shows a horizontally-divided double curtain trellis system 10 according to one version 100 of the invention. The trellis system comprises a frame 110 that supports a series of trellis wires. The frame 110 includes multiple openings 120 that support the trellis wires. By providing two or more frames 110 along a row of vines, the trellis wires can be supported to run generally parallel to one another along the row of vines. The frames 110 may be supported by posts or endposts.

Through the frame 110 runs a first cordon wire 130 and a second cordon wire 135. A vine V is planted into the ground G at a position beneath the trellis system 100. The vine's trunk T will divide into cordons or arms C as the vine grows. Each cordon is secured to a respective cordon wire by conventional means, such as plastic ties or wires. In this manner, the cordons are horizontally divided. From the cordons will grow canes and shoots from which grapes will grow. Through the frame 110 will also run one or more shoot positioning wires 140, 145 for positioning the shoots and support the growth. In the version shown in FIG. 1, one, two, or three or more shoot-positioning wires 140 are provided above the first cordon wire 130, and one, two, three or more shoot-positioning wires 145 are provided above the second cordon wore 135. The shoot-positioning wires 145 may extended vertically or may be angled outwardly, as shown in FIG. 1. In one version, the shoot-positioning wires extend outwardly at an angle of about 70 to 80 degrees relative to a plane formed by the two cordon wires. One or a pair of trunk wires 150 may be positioned above the trunk and between the cordon wires 130, 135 to support the trunk and/or to support each cordon as it is wrapped over the trunk wire 150 on its way to its cordon wire. Alternatively, there can be no trunk wire 150 and the cordons will extend directly to the cordon wires 130, 135. In another version, a trunk wire 150 or pair may be provided that runs through a different frame or is merely supported by end posts.

The exact dimensions of the frame 110 may vary depending on the grape variety and geography of the vineyard. In the version shown, it has been determined that the height of the trunk wire 150 and/or the cordon wires 130, 135 be from about 25 to about 40 inches, or from about 28 to about 34 inches, or from about 30 to 32 inches. The cordon wires 130, 135 may be spaced apart from one another by about 20 to 50 inches, or from about 25 to 40 inches, or from about 30 to 35 inches. Each of the shoot-positioning wires 140, 145 may be spaced apart from a cordon wire 130,135 or from another shoot-positioning wire by from about 8 to 15 inches. In one particular version that has proven to be very effective, the trunk wire 150 is positioned about 1 inch or more, or form about 1 to about 12 inches, or from about 2 to about 5 inches above a line extending from the first cordon wire 130 to the second cordon wore 135. In this particular version, a cordon C extends over the trunk wire 150 and above the cordon plane and then extends relatively downward to the cordon plane where it is secured to a respective cordon wire. With this version, stress is removed from the cordon wire and the cordon itself at the position of the cordon wire.

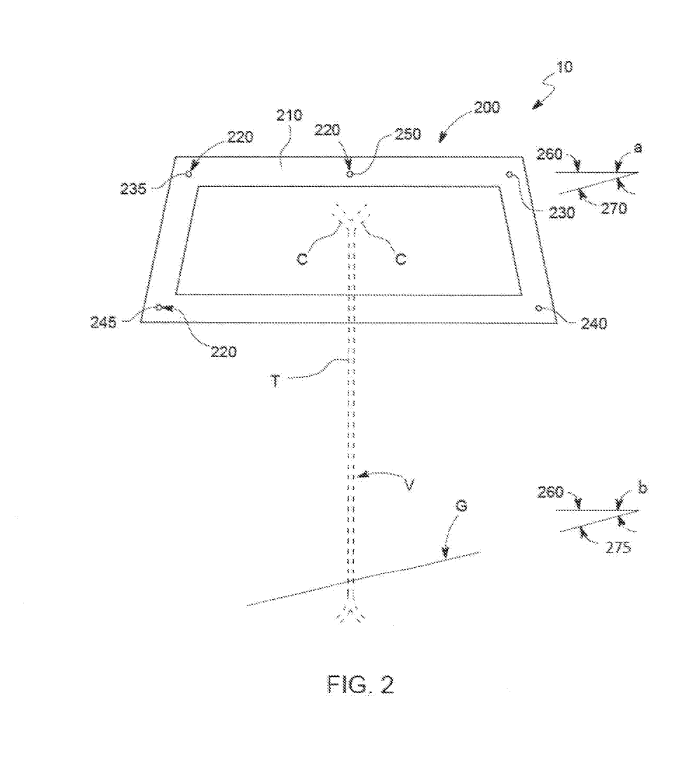

FIG. 2 shows a horizontally-divided double curtain trellis system 10 according to another version 200 of the invention. The trellis system 200 comprises a frame 210 that supports a series of trellis wires. The frame 210 includes multiple openings 220 that support the trellis wires. By providing two or more frames 210 along a row of vines, the trellis wires can be supported to run generally parallel to one another and along the row of vines.

Through the frame 210 runs a first cordon wire 230 and a second cordon wire 235. A vine V is planted into the ground G at a position beneath the trellis system 200. The vine's trunk T will divide into cordons or arms C as the vine grows. Each cordon is secured to a respective cordon wire by conventional means, such as plastic ties or wires. In this manner, the cordons are horizontally divided. From the cordons will grow canes and shoots from which grapes will grow. Through the frame 210 will also run one or more shoot positioning wires 240, 245 for positioning the shoots and support the growth. In the version shown in FIG. 2, one shoot-positioning wire 240 is provided below the first cordon wire 230, and one shoot-positioning wire 245 are provided above the second cordon wore 235. The shoot-positioning wires 240,245 may extended vertically or may be angled outwardly, as shown in FIG. 2. In one version, the shoot-positioning wires extend outwardly at an angle of about 70 to 80 degrees relative to a plane formed by the two cordon wires. One or a pair of trunk wires 250 may be positioned over the trunk to support the trunk and/or to support each cordon as it is wrapped over the trunk wire 250 on its way to its cordon wire. Alternatively, there can be no trunk wire 250 and the cordons will extend directly to the cordon wires 230, 235. In another version, a trunk wire 250 or pair may be provided that runs through a different frame or is merely supported by end posts.

The exact dimensions of the frame 210 may vary depending on the grape variety and geography of the vineyard. In the version shown, it has been determined that the height of the trunk wire 250 and/or the cordon wires 230, 235 be from about 40 to about 70 inches, or from about 48 to about 64 inches, or from about 52 to 56 inches. The cordon wires 230, 235 may be spaced apart from one another by about 20 to 55 inches, or from about 25 to 50 inches, or from about 30 to 44 inches. Each of the shoot-positioning wires 240, 245 may be spaced apart from a cordon wire 230, 235 or from another shoot-positioning wire by from about 8 to 25 inches. In one particular version that has proven to be very effective, the trunk wire 250 is positioned about 1 inch or more, or form about 1 to about 12 inches, or from about 2 to about 5 inches below a line extending from the first cordon wire 230 to the second cordon wore 235. In this particular version, a cordon C extends over the trunk wire 250 below the cordon plane and then extends relatively upward to the cordon plane where it is secured to a respective cordon wire. With this version, stress is shared between the cordon wires and the trunk wires, and the cordon itself has less localized less at the position of either the cordon wire or the trunk wire.

The choice of whether to use the trellis system 10 of the first version 100 or the second version 200 may depend on many factors, such as soil, climate, geography and topography. However, one of the most important factors is grape variety. The first version 100 is ideally suited for grape varieties with a an upright growing habit, such as cabernet sauvignon, merlot, grenache, mourvedre, and petite sirah. The second version 200 is ideal for grape varieties with a downward growing habit, such as syrah or shiraz.

In another aspect of the invention, the horizontally-divided trellis system 10 of the present invention may be used to adapt an undesirable aspect or ground slope into a more desirable one. Depending on the elevation and climate, it may be considered most ideal to grow grapes on a slope that faces a particular direction. For example, some varieties in the Northern Hemisphere prefer a south-facing slope in order to maximize the sunlight exposure throughout the growing season. Others may do best with a north-facing slope in order to minimize the direct sunlight. Still others may benefit from an east-facing slope or a west-facing slope to receiving morning or afternoon direct sunlight, respectively. The opposites are true for Southern Hemisphere vines. With the current trellis system 10, a desired directional-facing slope can be mimicked on any slope or flat surface. By tilting the frame 110, 210 of the trellis systems toward the desired direction, the horizontally-divided curtains will be tilted by the same amount. As a result, the vine canopies will be exposed to the sun as if they were on a desired directional-facing slope.

For example, viewing FIG. 1, the line 170 can represent the horizontal level generally perpendicular to the direction of the row. The line 170 has a slope of 0 degree when measured with a carpenter's level. The line 160 represents the line formed by the first cordon wire 130 location and the second cordon wire 135 location on the frame 110. By tilting the frame so that the line 160 is tilted relative to the horizontal level 170 as defined by a horizontally level plane, the frame will be angled in that direction relative to the horizontal by an angle, a. As a result the canopy of the vine will be exposed to the sun as if it were positioned on a slope that was facing that direction and at that angle. For example, is the row runs due east and west and FIG. 1 is facing in the eastern direction, the frame 110 of FIG. 1 would be tilted towards the south by the angle, a.

Accordingly, in one version of the invention, the trellis 10 comprises a frame 110 that supports a first cordon wire 130 and a substantially parallel second cordon wire 135 in a manner where a line perpendicularly connecting the first cordon wire 130 and the second cordon wire 135 is tilted relative to a horizontally level line or plane by an angle, a. In one version, the angle, a, is at least about 5 degrees. In another version, the angle, a, is at least about 10 degrees. In another version, the angle, a, is at least about 15 degrees. In another version, the angle, a, is at least about 20 degrees.

The frame 110 and the supported cordon wires 130, 135 can additionally or alternatively be tilted relative to the ground, G. As shown in FIG. 1, the slope of the G can be represented by the line 175. And the angle of tilt can again be represented by the line 160 or a line parallel to 160. The angle of tilt between the line of the cordon wires 160 and the ground is angle, b. If the ground G, is generally level, by making the angle, a, between the lines 160, 170 equal to 10 degrees, the result will be a frame that is tilted 10 degrees towards the desired direction. Similarly, if the ground G is sloped 5 degrees to the one direction, by making the angle, b, equal to 10 degrees, the result will be a frame that is titled 5 degrees relative to the horizontal level towards the opposite direction.

Accordingly, in one version of the invention, the trellis 10 comprises a frame 110 that supports a first cordon wire 130 and a substantially parallel second cordon wire 135 in a manner where a line perpendicularly connecting the first cordon wire 130 and the second cordon wire 135 is tilted relative to the slope of the ground by an angle, b. In one version, the angle, b, is at least about 5 degrees. In another version, the angle, b, is at least about 10 degrees. In another version, the angle, b, is at least about 15 degrees. In another version, the angle, b, is at least about 20 degrees. In another version, the angle, b, is at least about 30 degrees. In another version, the angle, b, is at least about 40 degrees.

The slope of the ground G can in some cases be hard to determine because of holes or mounds or variations in curvature. Thus, the expression slope of the ground is to be considered the general and average slope of the ground in the area containing a plurality of adjacent vines. The plurality of adjacent vines can be two vines, three vines, five vines, ten vines, or an entire row of vines. The slope of the ground may also be in various planes. However, the slope of the ground of interest is the slope in the direction generally perpendicular to the direction of the row of the trellis or adjacent vines. Thus, for a due north-facing slope of 10 degrees, the slope of the ground for a due east-west row would be 10 degrees. For a due northwest-facing slope of 10 degrees, the slope of the ground relevant to a due east-west row would be 5 degrees. And for a due west-facing slope of 10 degrees, the slope of the ground relevant to a due east-west row would be 0 degrees.

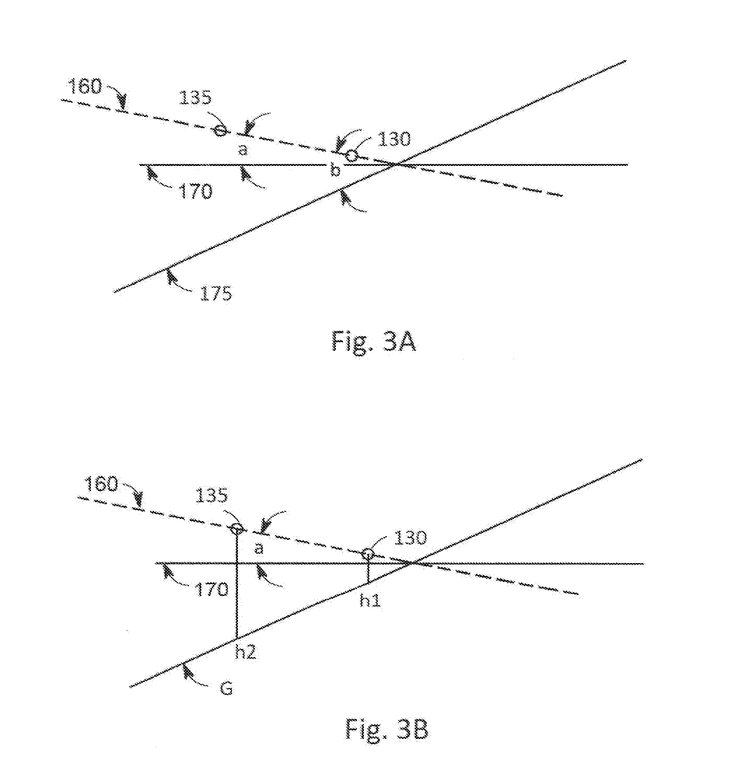

The relative angles are illustrated in FIG. 3A. Line 160 is a line extending through the first cordon wire 130 and the second cordon wire 135 that runs substantially perpendicular to the wires. Line 170 is the horizontal level in a direction substantially perpendicular to the cordon wires. Line 175 is a line parallel to the slope of the ground as defined above. Angle, a, is the angle between lines 165 and 170. Angle, b, is the angle between lines 160 and 175. In the example, of FIG. 3A, if the ground slopes due north at 20 degrees, an angle, b, of 30 degrees would provide a tilt towards due south of 10 degrees. Angle, a, is thus 10 degrees. The trellis 10 can also be used to accentuate a slope. For example, if the slope of the ground is 10 degrees due south, an angle, b, tilt of 10 degrees will provide an effective slope of 20 degrees due south (angle a). All of the angles are acute angles and of absolute value.

FIG. 3B illustrates another manner of expressing the tilt. In this version, instead of measuring the angle of tilt (angle b) of the wires with respect to the slope of the ground, one can measure the vertical height, h1, of the first cordon from the ground directly below and the vertical height, h2, of the second cordon from the ground directly below. In one version, h1 and h2 differ by at least 3 inches. In another version, h1 and h2 differ by at least 6 inches. In another version, h1 and h2 differ by at least 9 inches. In another version, h1 and h2 differ by at least 12 inches. To account for minor topographical issues, h1 and h2 can be the average heights taken at adjacent vines. In one version, this can be the average of 2 adjacent vines. In another version, this can be the average of 3 adjacent vines. In another version, this can be the average of 5 adjacent vines. In another version, this can be the average of 10 adjacent vines. In another version, this can be the average of an entire row of vines.

All of the above angles and heights can be applied to the the frame 210 of the second version 200 as shown in FIG. 2 with 260 being the line extending perpendicularly between first and second cordon wires 230, 235. Line 260 corresponds to line 160. The horizontal level 270 corresponds to horizontal level 170. And the ground slope 275 and/or heights corresponds to 175 and the h1 and h2, respectively.

A row of grape vines will typically be supported by two or more frames 110, 210 with the wires being supported by the frames. Each of the frames 110, 210 can be tilted in any of the manners described above so that the cordon wires are angled as desired. In one version, two frames can be tilted at the same angle as one another. In another version, two frames adjacent to one another in a row of vines can be tilted relative to one another at different angles. The latter version can be used, for example, to account for changing slopes of the ground in different areas of the vineyard.

Although the present invention has been described in considerable detail with regard to certain preferred versions thereof, other versions are possible, and alterations, permutations and equivalents of the version shown will become apparent to those skilled in the art upon a reading of the specification and study of the drawings. For example, the cooperating components may be reversed or provided in additional or fewer number. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

What is claimed is:

1. A trellis system for training a row of grape vines, the trellis system comprising:
a frame supporting a first cordon wire and a second cordon wire, wherein the two cordon wires are substantially parallel to one another;
wherein the frame is mounted relative to the ground so that a line extending through the first cordon wire and the second cordon wire and substantially perpendicular thereto is tilted relative to a horizontally level plane, and wherein the line is tilted relative to the slope of the ground directly below the first cordon wire and the second cordon wire.

2. A trellis system according to claim 1 wherein the frame further supports one or more trunk wires intermediate the first cordon wire and the second cordon wire.

3. A trellis system according to claim 1 wherein the line is tilted relative to the horizontally level plane by an angle of at least 10 degrees.

4. A trellis system according to claim 1 wherein the line is tilted relative to the horizontally level plane by an angle of at least 15 degrees.

5. A trellis system according to claim 1 wherein the line is tilted relative to the slope of the ground by an angle of at least 10 degrees.

6. A trellis system according to claim 1 wherein the line is tilted relative to the slope of the ground by an angle of at least 20 degrees.

7. A trellis system according to claim 1 wherein the frame further supports one or more shoot positioning wires associated with each of the cordon wires.

8. A trellis system according to claim 1 further comprising a second frame supporting the first cordon wire and the second cordon wire, wherein the frames are tilted at the same angle.

9. A trellis system according to claim 1 further comprising a second frame supporting the first cordon wire and the second cordon wire, wherein the frames are tilted at the different angles.

10. A trellis system according to claim 1 wherein the first cordon wire and the second cordon wire support one or more cordons from a plurality of grape vines.

11. Wine produced from grapes grown on the trellis system of claim 10.

12. A trellis system for training a row of grape vines, the trellis system comprising:
a frame supporting a first cordon wire and a second cordon wire, wherein the two cordon wires are substantially parallel to one another;
wherein the frame is mounted relative to the ground so that a line extending through the first cordon wire and the second cordon wire and substantially perpendicular thereto is tilted relative to a horizontally level plane, and wherein the vertical height of the first cordon from ground directly below is different than the vertical height of the second cordon from the ground directly below.

13. A trellis system according to claim 12 wherein the frame further supports one or more trunk wires intermediate the first cordon wire and the second cordon wire.

14. A trellis system according to claim 12 wherein the difference between the vertical height of the first cordon from the ground and the vertical height of the second cordon from the ground is at least 6 inches.

15. A trellis system according to claim 12 wherein the difference between the vertical height of the first cordon from the ground and the vertical height of the second cordon from the ground is at least 12 inches.
